(19) United States
(12) Patent Application Publication
(10) Pub. No.: US 2025/0189981 A1
(43) Pub. Date: Jun. 12, 2025

(54) Transport Robot and Method and System for Operating a Transport Robot in a Warehouse

(71) Applicant: STILL GmbH, Hamburg (DE)

(72) Inventors: Volker Viereck, Kühsen (DE); Tino Krueger-Basjmeleh, Halstenbek (DE)

(21) Appl. No.: 18/969,750

(22) Filed: Dec. 5, 2024

(30) Foreign Application Priority Data
Dec. 6, 2023 (DE) 10 2023 134 148.0

(51) Int. Cl. G05D 1/644; G05D 1/229; G05D 101/00; G05D 105/28; G05D 107/70; G05D 111/10

(52) U.S. Cl. CPC G05D 1/644; G05D 1/229; G05D 2101/22; G05D 2105/28; G05D 2107/70; G05D 2111/10

(57) ABSTRACT

A transport robot is disclosed to carry out transport orders for transport of goods in a warehouse with a plurality of transport robots. The transport robot includes a communication interface to receive an environment model of the warehouse and a capability model of the plurality of transport robots. The environment model defines a plurality of key points of the warehouse and, for each key point, at least one neighboring key point. The capability model defines, for each of the key points of the environment model, movement sequence information for an automated movement to the at least one neighboring key point. For each key point of the environment model, the movement sequence information of the capability model is based on at least one movement learned by imitation learning of a manually operated transport robot of the plurality of transport robots between the key point and at least one neighboring key point.

### CROSS-REFERENCE TO RELATED APPLICATION

This application claims priority to German Patent Application No. 10 2023 134 148.0 filed Dec. 6, 2023, the disclosure of which is hereby incorporated by reference in its entirety.

### BACKGROUND OF THE INVENTION

### Field of the Invention

This invention relates to a transport robot and a method and system for operating such a robot in a warehouse.

### Description of Related Art

Load carriers such as mesh boxes or pallets, in particular Europallets, are frequently used for the transport and storage of products, goods and materials. Industrial trucks such as forklift trucks, for example, transport robots etc. are used for the handling of load carriers of this type, e.g. in intralogistics operations, i.e. the internal flow of materials, e.g. in a warehouse. A warehouse is generally a highly dynamic environment in which the control of the mobile industrial trucks is generally either manual, semi-automated or automated.

In intralogistics operations, the strong growth in connection with demographic changes is creating a demand for automated solutions. However, the introduction of new, more complex digital technologies is complicated by the fact that employees with a high level of personal qualifications are frequently under-represented in the area of intralogistics operations.

Current automation solutions for the transport of general cargo in intralogistics operations are essentially based on continuous conveyors, storage and retrieval units and driverless transport systems (FTS). Continuous conveyors and storage and retrieval units are ostensibly used everywhere rigid process chains and high material throughput rates are required, while driverless transport systems offer greater opportunities for use in intralogistics operations.

The causes of the somewhat hesitant pace of the introduction of current automation solutions include the high investment costs connected with current automation solutions, the increased amount of space required and frequently the infrastructure already in place for manual processes.

Automation solutions such as driverless transport systems (FTS) are also operated on pre-defined routes for transport. When adjustments to the transport layout are made, these routes must be re-planned, which results in a reduced degree of flexibility.

Therefore, for a plurality of potential additional areas of application where greater flexibility is required, there are either no economical solutions, or the current technical solutions entail high re-planning costs on account of their dynamics of change. Consequently, current automation solutions are only a niche product compared to manually-oriented transport solutions.

Autonomous mobile robots (AMRs), e.g. in the form of transport robots, are characterized by greater flexibility than FTS (driverless transport systems). However, AMRs that move in a plurality of open environments and perform a plurality of tasks and interactions require explicit capabilities to be able to perform their tasks. AMRs interact with their environment in a sensor-motor way and must act consciously to perform their task. In this context, conscious action means that the AMRs perform tasks that are motivated by specified goals and are justified and/or optimal for these goals by considerations that are dependent on environmental models. These deliberative capabilities are a characteristic of AMRs compared to FTS.

However, for automatic transport by AMRs, in particular transport robots, the knowledge for the creation of the routes, navigation maps and the subsequent actions (e.g. retrieving and depositing loads, waiting, loading etc.) must be transmitted to the AMRs. The transmission of this knowledge requires interventions by highly specialized technical personnel for the adaptation of the AMRs to their subsequent use. This makes up the greatest portion of the commissioning and adaptation expenses and limits the fields of action on account of the related costs and human resources.

However, the knowledge of the routes and the corresponding locations of action in a warehouse is in the form of knowledge of the warehouse and application. The warehouse employees are precisely the people who have a great deal of application knowledge which, if it were made available to the machines, could be used as the basis of the performance of the tasks of industrial trucks configured as AMRs.

### SUMMARY OF THE INVENTION

Against this background, the object of the present invention is to make available an improved transport robot and a method and system for the commissioning, adaptation and operation of a transport robot of this type in a warehouse.

This object is accomplished according to a first aspect by a transport robot for operation in a warehouse. The transport robot can be an industrial truck, in particular a forklift truck. The transport robot, the operation of which can be fully automated, semi-automated and/or manual, is configured to carry out transport orders for the transport of goods in a warehouse with a plurality of transport robots. The transport robot thereby comprises a communication interface, for example a communication interface for wireless communication via a wireless communication network, wherein the communication interface is configured to receive and/or send an environment model of the warehouse and a capability model of the plurality of transport robots in the warehouse. In one embodiment, the communication interface of the transport robot is configured to obtain the environment model of the warehouse and the capability model of the plurality of transport robots in the warehouse from a central device, for example a server for the operation of the plurality of transport robots. The transport robot can also receive transport orders from the central device. In an additional embodiment, the communication interface of the transport robot is configured to obtain the environment model of the warehouse and the capability model of the plurality of transport robots in the warehouse from another transport robot of the plurality of transport robots.

According to the invention, the environment model of the warehouse defines a plurality of unambiguous key points (including in the form of semantic key points or nodes) of the warehouse in the form of a topological map in which each key point has at least one neighboring key point, i.e. connected by means of an edge of the topological map. The capability model of the plurality of transport robots defines or comprises, for each of the key points of the environment model, i.e. of the topological map, movement sequence data, in particular at least one trajectory, for an automated movement from the corresponding key point to the at least one neighboring key point. In other words, the capability model with the movement sequence data, in particular trajectories, for each key point of the environment model enables the transport robot to connect neighboring key points of the environment model with one another. For each key point of the plurality of key points of the environment model, according to the invention, the movement information, in particular the at least one trajectory of the capability model (which is linked with the corresponding key point) is based on at least one movement learned by imitation learning of a transport robot operated at least partly manually, i.e. by an employee, of the plurality of transport robots between the key point and the at least one neighboring key point. The transport robot further comprises a control unit which is configured to carry out a transport order from a starting key point to a destination key point of the plurality of key points, to automatically control the movement of the transport robot on the basis of the environment model and of the capability model. According to the invention, therefore, the expert knowledge or know-how required for the automatic operation of the transport robot is transmitted to the transport robot as imitation knowledge in the form of the capability model.

According to one embodiment, the control unit for the performance of the transport order from the starting key point to the destination key point of the plurality of key points can be configured to automatically control the movement of the transport robot, in particular of an industrial truck, on the basis of the environment model and first movement sequence data, in particular of a first trajectory, and at least second movement sequence data, in particular of at least a second trajectory, of the capability model, wherein the first movement sequence data, in particular the first trajectory, defines a movement from the starting key point to an intermediate key point neighboring the starting key point and wherein the at least second movement sequence data, in particular the at least one second trajectory, defines a movement from the intermediate second movement sequence data, in particular the at least one second trajectory, defines a movement from the intermediate key point to the destination key point or a movement from the intermediate key point to an additional intermediate key point neighboring the intermediate key point.

In one embodiment, the control unit is further configured, after the movement of the transport robot from the starting key point to the intermediate key point, which is done on the basis of the first movement sequence data, in particular of the first trajectory, to vary a cumulative deviation of a current position or current pose from a specified position or specified pose of the transport robot relative to the intermediate key point and to counteract the movement of the transport robot from the intermediate key point to the destination key point or the additional intermediate key point, which is done on the basis of the second movement sequence data, in particular of the second trajectory, to counteract the deviation.

According to one embodiment, the control unit can further be configured, by means of a cost function, to determine the movement of the transport robot from the starting key point to the destination key point via the one or more intermediate key points lying between them.

According to one embodiment, each key point of the plurality of key points can have an artificial marking (such as a marker, for example), and the transport robot can further have a sensor unit which is configured to detect the marking of a respective key point and to identify the respective key point on the basis of the marking detected.

In one embodiment, the control unit of the transport robot is configured, on the basis of the artificial marking detected by the sensor unit of a respective key point to determine the position, in particular the pose, of the transport robot relative to the respective key point.

According to one embodiment, the marking of the respective key point can be a visual marking and the sensor unit of the transport robot can be in the form of a camera, in particular, a depth image camera for the detection of the visual marking of the respective key point.

In one embodiment, the transport robot further comprises a drive unit which is configured to drive the movement of the transport robot on the basis of movement control signals from the control unit. The drive unit can comprise, for example, a plurality of drive wheels and an electric drive motor to drive the plurality of drive wheels.

According to a second aspect, the above-mentioned task is accomplished by a system for the operation of a plurality of transport robots in a warehouse. The system thereby comprises a plurality of transport robots according to the first aspect of the invention and a central device for the operation of the plurality of transport robots in the warehouse, wherein the central device is configured to make available to each transport robot of the plurality of transport robots the environment model of the warehouse and the capability model of the plurality of transport robots.

According to a third aspect, the above-mentioned object is accomplished by a method for the operation of a transport robot, in particular an industrial truck, the operation of which can be automated, semi-automated and/or manual, to carry out transport orders for the transport of goods in a warehouse with a plurality of transport robots. The method thereby comprises the following steps:
Obtaining an environment model of the warehouse and a capability model of the plurality of transport robots in the warehouse (optionally from a central device for the operation of the plurality of transport robots), wherein the environment model of the warehouse defines a plurality of key points of the warehouse, and for each key point at least one neighboring key point, and wherein the capability model defines for each of the key points of the environment model movement sequence data, in particular at least one trajectory, for an automated movement to the at least one neighboring key point, wherein for each key point of the plurality of key points of the environment model the movement sequence data, in particular the at least one trajectory, of the capability model is based on at least one movement learned by imitation learning of a manually operated transport robot of the plurality of transport robots between the key point and the at least one neighboring key point; and
Control of the movement of the industrial truck on the basis of the environment model and of the capability model, to carry out a transport order from a starting key point to a destination key point of the plurality of key points.

### BRIEF DESCRIPTION OF THE DRAWINGS

The terms Fig., Figs., Figure, and Figures are used interchangeably in the specification to refer to the corresponding figures in the drawings.

Additional advantages and details of the invention are further explained by way of example on the basis of the exemplary embodiments illustrated in the accompanying schematic figures, in which:

FIG. 1 is a schematic illustration of a transport robot in the form of an industrial truck for the transport of goods in a warehouse according to one embodiment;

FIG. 2 is a schematic illustration of a system according to the invention with a plurality of transport robots in the form of industrial trucks and a central device for the provision of an environment model and of a capability model for the operation of the plurality of transport robots;

FIG. 3a is an illustration of a transport robot according to one embodiment in a warehouse shown by way of example with a key point in the form of a branch;

FIG. 3b is an illustration of an environment model of the warehouse in FIG. 3a;

FIG. 3c is an illustration of a transport robot according to one embodiment in a warehouse shown by way of example with two neighboring key points and the automated movement of the transport robot on the basis of the capability model;

FIG. 3d is an illustration of an environment model of the warehouse in FIG. 3c;

FIG. 3e is an illustration of the movement of a transport robot according to one embodiment on the basis of the capability model from a starting key point via an intermediate key point to a destination key point;

FIG. 3f illustrates an automated correction of the movement in FIG. 3e by a transport robot according to one embodiment; and

FIG. 4 is a flow diagram showing the steps of a method for the operation of a transport robot for the transport of goods in a warehouse according to one embodiment.

### DESCRIPTION OF THE INVENTION

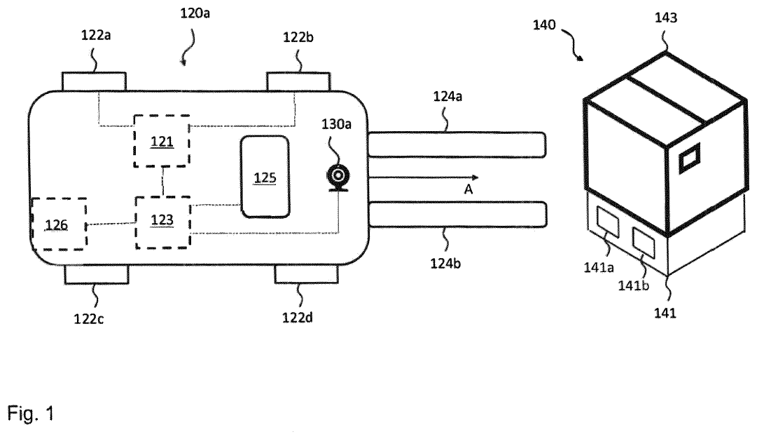

FIG. 1 is a schematic illustration of a transport robot 120a configured as an industrial truck in the form of a forklift truck 120a according to one embodiment for the transporting of goods 140 in an industrial environment, in particular a warehouse. The transport robot 120a configured as an industrial truck can be in particular an intermittently autonomous, semi-autonomous and/or manually operated forklift truck 120a, i.e. one guided by an operator. The goods 140 can be, for example, inventory items 143, such as packing boxes 143 that are located on a respective load carrier 141. The load carrier 141 can be, for example, a pallet 141, in particular a Europallet 141 or a mesh box 141.

As shown in FIG. 1, the transport robot 120a configured as an industrial truck comprises load handling means in the form of a pair of load forks 124a,b, which are configured to be inserted into respective recesses, in particular pockets 141a,b on one end side of the load carrier 141, to accept the load carrier 141 and the inventory item 143 located on it According to additional embodiments, the load handling means can also be configured in the form of a spike, for example to accept rolls of film or coils of wire, as a linking load handling means (e.g. comparable to waste hauling trucks for the pickup of waste bins) or in the form of bale or roll clamps, for example to pick up rolls of paper.

The transport robot 120a configured as an industrial truck 120 illustrated in FIG. 1 comprises a drive unit 121, for example at least one motor 121, in particular an electric motor 121, wherein the drive unit 121 is configured to move the industrial truck 120a and the pair of load forks 124a,b relative to the item 140, for example to modify the orientation and/or the distance between the industrial truck 120a and the item 140 and/or to raise and lower the pair of load forks 124a,b. For this purpose, as indicated in FIG. 1, the drive unit 121 is appropriately connected with wheels 122a-d and/or the pair of load forks 124a,b of the industrial truck 120a.

The transport robot 120a in the form of an industrial truck 120a can also comprise a sensor unit 130a, in particular an image acquisition unit 130a, which is configured to acquire, during the movement of the transport robot 120a, a plurality of images of the environment of the industrial truck 120a. The image acquisition unit 130a preferably comprises a camera 130a, in particular a depth sensing camera 130a. As indicated in FIG. 1, the image acquisition unit 130a is preferably mounted on the transport robot 120a configured as an industrial truck 120a so that the field of view of the image acquisition device 130a lies essentially along a direction A of forward movement of the transport robot 120a. The image acquisition device 130a can preferably be mounted in the plane of symmetry between the two load forks 124a,b. In addition to the image acquisition device 130a with the field of view along the direction A of forward movement of the transport robot 120a, the transport robot 120a in the form of an industrial truck 120a can comprise additional image acquisition devices or sensor units, for example an image acquisition device with a field of view along a direction of reverse movement of the transport robot 120a and/or an image acquisition device with a field of view perpendicular to the direction A of forward movement of the transport robot 120a.

According to the invention, the transport robot 120a in the form of an industrial truck 120a further comprises a control unit 123 which can comprise, for example, one or more processors or micro-controllers with appropriate software that can control the transport robot 120a in the form of an industrial truck 120a in an at least semi-automated manner, as described in greater detail below.

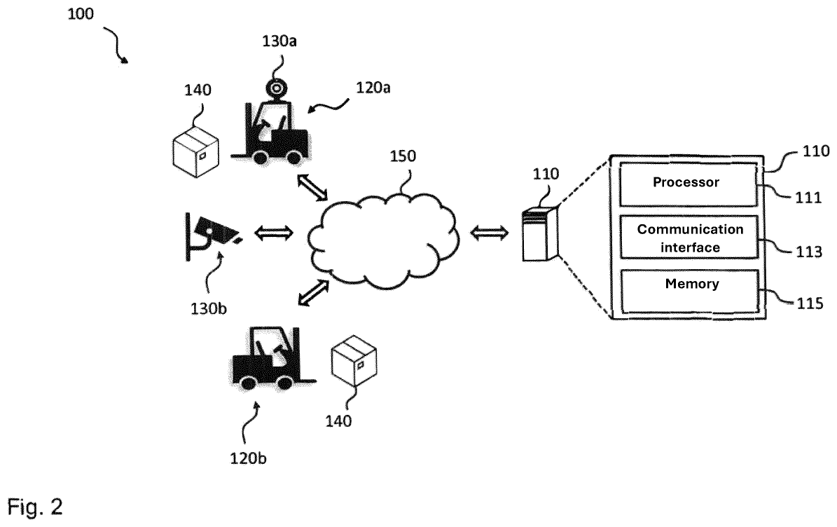

FIG. 2 is a schematic illustration of a system 100 according to the invention for the operation of the transport robot 120a in the form of an industrial truck 120a and at least one additional transport robot 120b in the form of an industrial truck 120b, the operation of each of which can be automated, semi-automated and/or manual, to carry out transport orders for the transport of goods 140 in a warehouse.

The system 100 comprises, in addition to the plurality of transport robots 120a,b, a central management device 110 such as a server 110, for example, which is configured to communicate with each transport robot 120a,b of the plurality of transport robots 120a,b, and to transmit to each of the plurality of transport robots 120a,b, for example, transport orders for the transport of goods 140 in the warehouse. For this purpose, for example, the transport robot 120a in the form of an industrial truck comprises a communication interface 126 which is configured to communicate with a corresponding communication interface 113 of the central management device 110 and with an external sensor unit 130b, such as, for example, a sensor unit 130b of the warehouse, for example via a wireless communication network 150, e.g. a wi-fi network or a mobile radio or cellular telephone network. The central management device 110 illustrated in FIG. 2 can be, for example, an industrial PC 110 or a cloud server, in particular an edge cloud server 110.

As shown in FIG. 2, the central management device 110, in addition to the above-mentioned communication interface 113, can have one or more processors 111 and a memory 115, in particular a non-volatile memory 115. The memory 115 can be configured, for example, to store data and executable program code which, when executed by the processor 111 of the central management device 110, causes the processor 111 to execute the functions, operations and processes described below.

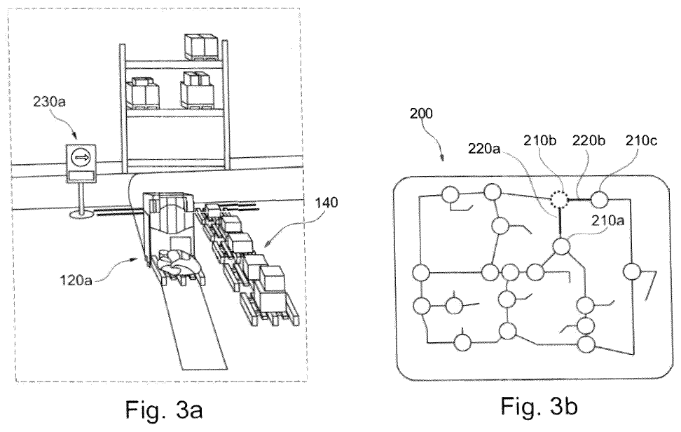

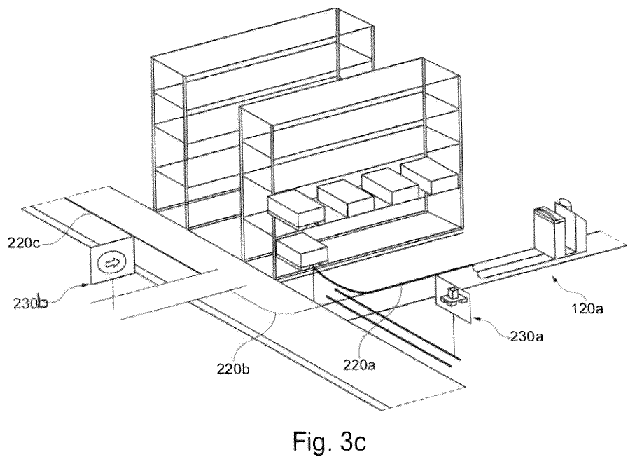

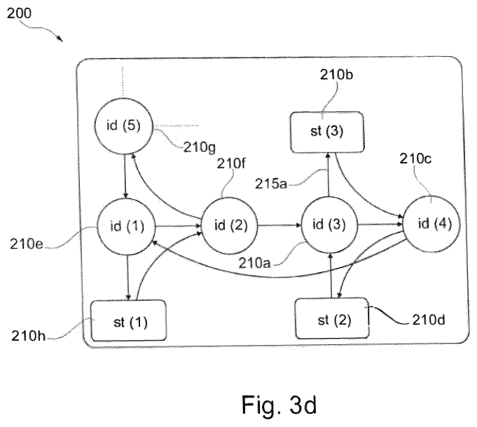

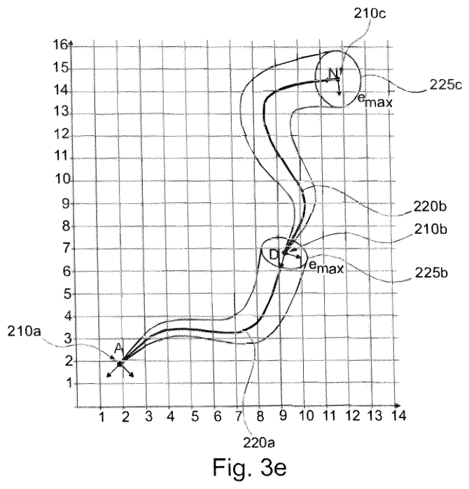

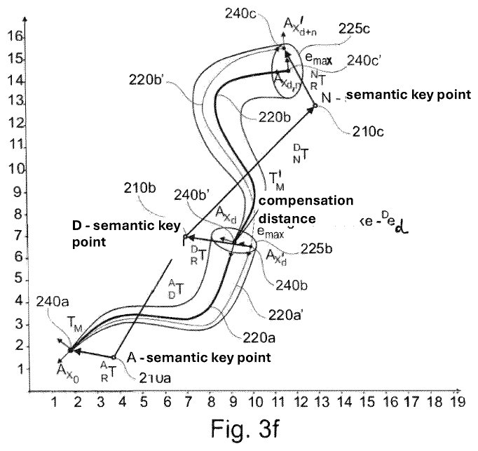

As will be described in detail below with further reference to FIGS. 3a-f, the communication interface 126 of the transport robot 120a in the form of an industrial truck is configured to receive an environment model of the warehouse (environment models 200 of a warehouse are illustrated by way of example in FIGS. 3b and 3d) and a capability model of the plurality of transport robots 120a,b in the warehouse. In one embodiment, the communication interface 126 of the transport robot 120a is configured to receive the environment model 200 of the warehouse and the capability model of the plurality of transport robots 120a,b in the warehouse from the central management device 110. In an additional embodiment, the communication interface 126 of the transport robot 120a is configured to receive the environment model 200 of the warehouse and the capability model of the plurality of transport robots 120a,b from another transport robot, e.g. the transport robot 120b, of the plurality of transport robots. As described in greater detail below, the environment model 200 of the warehouse and in particular the capability model of the plurality of transport robots 120a,b are based on imitation knowledge collected in the warehouse, which can advantageously be used in particular for the setup of a new transport robot in the warehouse.

In one embodiment, the central management device 110 is configured to generate the environment model 200 of the warehouse and the capability model of the plurality of transport robots 120a,b configured as industrial trucks and to make it available to the transport robots 120a,b in the form of industrial trucks. In an additional embodiment the plurality of transport robots can generate the environment model of the warehouse and the capability model in a distributed manner.

As described in greater detail below, the environment model 200 of the warehouse defines a plurality of unambiguous key points 210a-c (hereinafter also referred to as semantic key points 210a-c or nodes 210a-c) of the warehouse in the form of a topological map. FIGS. 3a and 3c each show a detail of a warehouse with key points, and FIGS. 3b and 3d each show the corresponding environment model 200. As can be seen in particular in FIG. 3d, each key point 210a-h has at least one neighboring key point, i.e. one connected by means of an edge of the topological map. For example, in the environment model 200 shown by way of example in FIG. 3d, the key point 210a is connected by one edge 215a with the key point 210b.

As described in greater detail below, the capability model of the plurality of transport robots 120a,b defines or comprises for each of the key points 210a-h of the environment model 200, i.e. of the topological map 200, movement sequence data, in particular at least one trajectory, for an automated movement from the corresponding key point to the at least one neighboring key point or for the handling of pallets (automatic deposition or pickup). In other words, the capability model with the movement sequence data, in particular trajectories, for each key point of the environment model 200 enables the transport robot 120a to connect neighboring key points of the environment model 200 with one another.

In the example illustrated in FIG. 3c, the transport robot 120a according to the invention moves in an automated manner on the basis of a first trajectory 220a to a first key point provided with a first optical marking 230a. Then the transport robot 120a according to the invention is moved in an automated manner on the basis of a second trajectory 220b with a curve to the right from the first key point to a second key point provided with a second optical marking 230b to continue automated travel on the basis of a third trajectory 220c. As will be apparent to a person skilled in the art, the second trajectory 220b shown by way of example in FIG. 3c, which is part of the capability model, is linked with the first key point defined by the environment model, which is provided with the first marking 230a. Of course, the first key point defined by the environment model can also be linked with additional trajectories or movement sequence data of the capability model, for example with a trajectory which in the example illustrated in FIG. 3c describes a curve to the left.

For each key point of the plurality of key points 210a-h of the environment model 200, according to the invention the movement information, in particular the at least one trajectory of the capability model (which are linked with the corresponding key point) are based on at least one movement learned by imitation learning of an at least one transport robot operated at least partly manually, i.e. by an employee, of the plurality of transport robots between the key point and the at least one neighboring key point. In other words, during the manual operation of the transport robots in a warehouse, movement sequence data, in particular trajectories, can be recorded and collected to generate or to expand/update the capability model.

As will be apparent to the person skilled in the art, the environment model 200 and the capability model therefore define an annotated topological map of the warehouse with a plurality of key points 210a-h connected with one another, whereby by means of the capability model with each key point 210a-h, movement sequence data, e.g. at least one trajectory 220a-c, of the capability model is concatenated for the movement to at least one neighboring key point. This movement sequence data 220a-c of the capability model can, as described above, define or comprise a trajectory for the description of necessary travel commands to reach the neighboring key points, as well as other types of movement sequence data that describe more complex movements, for example for the deposition or pickup of pallets, the loading of the transport robot etc.

As described above, the transport robot 120a further comprises a control unit 123 which is configured to carry out a transport order from a starting key point to a destination key point of the plurality of key points 210a-h, to automatically control the movement of the transport robot 120a on the basis of the environment model 200 and of the capability model. According to the invention, therefore, the expert knowledge or know-how required for the automatic operation of the transport robot 120a is transmitted to the transport robot 120a in the form of the environment model 200 and as imitation knowledge in the form of the capability model. The transport robot 120a according to the invention in the form of an industrial truck 120a and the system 100 according to the invention thereby provide a mapping of automated goods transport by imitation. The location and handling information required for this purpose are generated concurrently by the observation of previously executed movements of a transport robot 120b configured in the form of an industrial truck (which can be identical or similar to the transport robot 120a) controlled manually (i.e. by a human being with expert knowledge, e.g. a warehouse employee), so that this information can be used for the generation or updating of the capability model. In this context concurrency describes an exploration phase of the plurality of transport robots 120a,b in the form of industrial trucks that automatically learn, by observation of the field of application during routine work, of all the movements executed and their geographic reference in the warehouse.

According to the invention, therefore, in the exploration phase, imitation knowledge in the form of environment knowledge can be learned automatically by observation of manual transports with the transport robots 120a,b in the form of industrial trucks. During the demonstration, for this purpose, as described above, the environment model 200 of the warehouse is generated in the form of a topological map 200, which is based on a plurality of semantic key points 210a-h of the warehouse. According to one embodiment, the semantic key points 210a-h may be considered for the transport of the goods 140 as locations of basic decisions in the warehouse in order to achieve the desired goal of automated transport orders. In addition to the information contained in the environment model 200, in addition, as described above, the capability model can also be learned, which is used for the concatenation between the previously observed semantic key points 210a-h.

In a subsequent exploitation phase, the imitation knowledge can be concatenated with the aid of AI-based handling planning with specific transport orders, so that the previously demonstrated manual transport operations can be executed automatically. Potential disruptions in the execution of the learned movements caused by faults intrinsic to the system or dynamic obstacles can be compensated for, for example, by an adapted state-lattice-path planner. The localization required for the execution of automatic movements in the space can be based on a proximity-based localization approach which, for metrically continuous localization requirements utilizes the concatenation of the nodes 210a-h of the environment model 200 (i.e. of the key points 210a-h) via the capability model, and thus does not require a singular reference point, such as a coordinate point of origin in metric maps.

According to one embodiment, each key point of the plurality of key points 210a-h can have an artificial marking 230a,b, as described above in connection with FIGS. 3a and 3c. A respective marking 230a,b is thereby configured so that it can be detected with the sensor unit 130a, in particular a camera 130a of the transport robot 120a in the form of an industrial truck, to identify the respective key point on the basis of the detected marking 230a,b. According to one embodiment, the sensor unit 130a can comprise, in addition to a camera, in particular a depth sensing camera, an infrared light source for the illumination of the field of view of the depth sensing camera.

In one embodiment, the control unit 123 of the transport robot 120a in the form of an industrial truck is configured, on the basis of the artificial marking 230a,b detected by the sensor unit 130a of a respective key point, to determine the position or pose 240a-c of the transport robot 120a in the form of an industrial truck relative to the respective key point 210a-c.

FIG. 3e illustrates the movement of the transport robot 120a according to one embodiment on the basis of the capability model from a position at a starting key point 210a via a position at an intermediate key point 210b to a position at a destination key point 210c of the environment model 200. FIG. 3f illustrates an automated correction of the movement in FIG. 3e by a transport robot 120a according to one embodiment, as will be described in greater detail below.

In the example illustrated in FIG. 3e, the control unit 123 of the transport robot 120a in the form of an industrial truck is configured to carry out the transport order from the starting key point 210a to the destination key point 210c of the plurality of key points 210a-c, to automatically control the movement of the transport robot 120a in the form of an industrial truck on the basis of the environment model 200 and first movement sequence data 220a, in particular of a first trajectory 220a, and at least second movement sequence data 220b, in particular of at least one second trajectory 220b, of the capability model. The first movement sequence data 220a, in particular the first trajectory 220a, defines a movement from the starting key point 210a to an intermediate key point 210b neighboring the starting key point 210a, and the at least second movement sequence data 220b, in particular the at least one second trajectory 220b, defines a movement from the intermediate key point 210b to the destination key point 210c. According to one embodiment, the control unit 123 of the transport robot 120 can further be configured, by means of a cost function, to determine the movement of the transport robot 120a in the form of an industrial truck from the starting key point 210a to the destination key point 210c via the one or more intermediate key points 210b lying between them. For example, the control unit 123 can determine, on the basis of the cost function, a route from the starting key point 210a to the destination key point 210c via one or more intermediate key points 210b lying between them, which minimizes the travel time or travel distance of the transport robot 120a.

As can be seen in particular in FIG. 3f, in one embodiment the control unit 123 of the transport robot 120a in the form of an industrial truck is further configured, after the movement of the transport robot 120a in the form of an industrial truck from the starting key point 210a to the intermediate key point 210b, which is based on the first movement sequence data 220a, in particular on the first trajectory 220a of the capability model, to determine a cumulative deviation of an current position or pose 240b from a specified position or specified pose 240b′ of the transport robot 120a in the form of an industrial truck relative to the intermediate key point 210b. As illustrated in FIG. 3f and described in greater detail below, the control unit 123 of the transport robot 120a according to one embodiment is configured to vary the movement of the transport robot 120a from the intermediate key point 210b to the destination key point 210c, which takes place on the basis of the specified trajectory 220b, in order to counteract the cumulative deviation at the intermediate key point 210b, which can be considered the integral error propagation.

According to one embodiment, the control unit 123 of the transport robot 120a is configured to counteract the integral error propagation illustrated in FIG. 3f during the movement to the intermediate key point 210b by the correction of the localization (proximity-based) at the intermediate key point 210b. For this purpose, in addition to the movement sequence data 220a, in particular the trajectory 220a for the movement to the intermediate key point 210b, the position of the intermediate key point 210b relative to the starting key point 210a can be stored in the environment model 200 (for example in the form of metadata) and used for the error correction.

According to one embodiment, for the realization of a metric localization for the individual mission, the position of the starting key point 210a is used as a reference point. As soon as, in the further course of the automated movement of the transport robot 120a, expected nodes of the environment model 200 surface, for example the intermediate key point 210b, these nodes can be used as correction variables on account of their known concatenated geometric relationship to the starting key point 210a. According to one embodiment, all relevant geometric relationships of the key points 220a-c can be taken from the topological map 200, i.e. from the environment model 200.

As described above, in the example illustrated in FIG. 3f, the movement of the transport robot 120 starts in the vicinity of the starting key point 210a (also designated node A in FIG. 3f), which is used as a reference point, and proceeds via the intermediate key point 210b (also designated node D in FIG. 3f) to the destination key point 210c (also designated node N in FIG. 3c). Therefore, the transport robot 120a starts its planned first trajectory 220a (i.e. the first specified trajectory 220a), which is part of the capability model, at the reference point A. On the assumption that the tracking of the first trajectory 220a, which maps the connection between the starting key point 220a (point A) and the intermediate key point 220b (point D), initially has no misalignment, the first actual trajectory 220a′ starts at the same pose as the planned first trajectory 220a. Because the localization of the semantic key point can be geographically limited, in one embodiment the location uses, in the further tracking of the movement of the transport robot 120a, odometry signals from the transport robot 120a. The odometry signals can generate a random error during the movement, resulting in the deviation illustrated in FIG. 3f between the specified trajectory 220a and the actual trajectory 220a′.

According to one embodiment, a successful localization depends on the cumulative error (hereinafter designated eₖ) at the end of the movement along a trajectory of the capability model permitting a recognition of the next node. The ellipses 225b and 225c shown in FIG. 3f define this destination area, in which the sensory location is possible, for the intermediate key point 210b and the destination key point 210c. When the destination area 250b is reached at the end of the movement from the starting key point 210a to the intermediate key point 210b, the intermediate key point 210b is used as a new reference point. The actual error can be calculated by the recognition of the intermediate key point 210b by the transport robot 120a. The error between the planned specified trajectory 220a and the actual trajectory 220b results from the difference between the expected pose and the measured pose according to the following equation:

$${}^{D} {e}_{d} = {}^{D} {x}_{d} - {}^{D} {x}_{d}^{′} with {}^{D} {x}_{d} = {( {}_{D}^{A} T )}^{- 1} \cdot {}^{A} {x}_{d}$$

With the error e_{d} determined in this manner, at the intermediate key point 201b at the time d, according to one embodiment, this error can be compensated for, to adjust the movement of the transport robot 120a back to a planned specified movement. On account of the non-holonomic properties of a plurality of transport robots, according to one embodiment, the compensation for the determined error is made by a compensation trajectory with an individual length. The path required for this purpose is represented in FIG. 3f as the broken-line portion of the actual trajectory 220b′. Therefore, the current cumulative error can be fully compensated for by the control unit 123 of the transport robot 120a.

As the transport robot 120a continues to move from the intermediate key point 210b to the destination key point 210c, an error can again occur (in particular on account of erroneous odometer signals), as soon as the transport robot 120a leaves the sensory node detection of the intermediate key point 210b. Until reaching the sensory perception of the destination key point 210c, the localization error, as during the movement from the starting key point 210a to the intermediate key point 210b, can now also increase during the current movement to the destination key point 210c. The error e can be recalculated as soon as the transport robot 120a enters the sensory detection range 225c of the destination key point 210c. For the overall movement from the starting key point 210a to the destination key point 210c, that means that the previously calculated error corrections make it possible to reach the next key point, if the transport robot 120a does not leave the maximum allowable error ellipse 225 (designated emax in FIG. 3f).

The generally derived calculation requirement for the determination of the error eₖ at the key point c and at the time k results from the concatenation of the nodes in the topological map 200 according to the following equation:

$${}^{c} {e}_{k} = {}^{c} {x}_{k} - {}^{c} {x}_{k}^{′} with t {}^{c} {e}_{k} = ( {\prod }_{i = S}^{c} {( {}_{i + 1}^{i} T )}^{- 1} ) \cdot {}^{s} {x}_{k}$$

The index S in the above equation corresponds in this context to the starting point of the movement of the transport robot at the starting key point 210a, while c represents the next expected key point. The notation Sxₖ corresponds to the current odometry-supported, error-corrected pose of the transport robot 120a at the discrete time k in the starting coordinate system.

As the person skilled in the art knows, according to the invention the number of mission nodes, i.e. key points, play no role in a successful localization. Only the relative pose between the neighboring nodes is necessary for the correction of the localization. In addition, the sensory detection of the nodes by the transport robot 120a must be possible to be able to calculate their relative pose.

The mapping of the environment of a warehouse according to the invention in the form of a topological map or environment model 200 has the immediate advantage that the location information can be stored in the form of a discrete planning network. This discrete planning network represents by means of its edges all the potential connections that the transport robot 120a can execute. The topological map can also unite the environment model 200 and the (learned) capabilities for the concatenation of neighboring nodes. The topological maps therefore fundamentally expand the geometric-semantic approach of current map models by the integration of a capability model. The capability model is used as a metric link between the nodes of the environment model 200. As a result of the connection of a plurality of nodes, a kinematic chain is formed which interrupts the accumulating unknown localization error at the node points (semantic key points), because the positions of the sensed nodes are environmentally invariant. Initially, two important deductions result from this observation.

Integral localization errors that result from external factors such as slip, malfunctioning sensor systems, digital losses etc. can be limited in their effects to the sensed nodes detected. Therefore, the annotated, topological maps described here minimize the risk of an invalid community map, as it is automatically learned and expanded by a fleet of transport robots. The map itself can thereby be replaced without further action.

The mappable geometric length of the trajectories of the capability model for the connection of the nodes is dependent only on the transport robot sensor system used, and can further be expanded to include sensory post-processing steps (e.g. visual odometry).

In an additional possible configuration, to restrict the resulting incremental error, which increases with increasing distance from the passed node point, a relative supporting localization can be used, e.g. with the aid of methods of visual odometry as well as colored roadway markings, curbstones etc. The distance between the support points in a warehouse can therefore be increased.

An additional advantage results from the mapping of logical information of the nodes perceived visually, if they have a direct mapping reference to the inventory management. In this case, the inventory management can work directly with the node information, so that the complex transfer of logical information of the inventory management into geometric information of the transport robot 120a,b is no longer necessary.

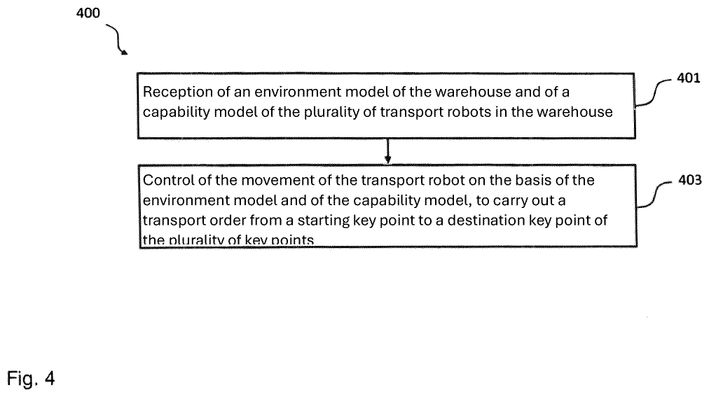

FIG. 4 shows a flow diagram with steps of a method 400 for the operation of a transport robot 120a in the form of an industrial truck, to carry out transport orders for the transport of goods 140 in a warehouse with a plurality of transport robots 120a,b in the form of industrial trucks. The method 400 comprises a step 401 of the receipt of an environment model 200 of the warehouse and of a capability model of the plurality of industrial trucks 120a,b in the warehouse. According to one embodiment, the transport robot 120a can receive the environment model 200 of the warehouse and/or the capability model of the plurality of industrial trucks 120a,b from the central control device 100 and/or from another industrial truck of the plurality of industrial trucks, for example from the transport robot 120b configured as an industrial truck.

As described in detail above, the environment model 200 of the warehouse defines a plurality of semantic key points 210a-h of the warehouse, and for each key point of the plurality of key points 210a-h, at least one neighboring key point, and the capability model defines, for each of the plurality of key points 210a-h of the environment model, movement sequence data, in particular at least one trajectory 220a-c for an at least semi-automated movement to the at least one neighboring key point. For each key point of the plurality of key points 210a-c of the environment model 200, according to the invention the movement sequence data 220a-c, in particular the at least one trajectory 220a-c of the capability model is based on at least one movement learned by imitation learning of an at least temporarily manually operated industrial truck 120b of the plurality of transport robots 120a,b configured as industrial trucks between the key point and the at least one neighboring key point of the plurality of key points 210a-c.

The method 400 further comprises a step 403 of the control of the movement of the transport robot 120a configured as an industrial truck on the basis of the environment model 200 and the capability model, to carry out a transport order from a starting key point 210a to a destination key point 210c of the plurality of key points 210a-h. As described above, this movement from the starting key point to the destination key point can take place via one or more intermediate key points.

The method 400 according to the invention can be carried out by means of the transport robot 120a in the form of an industrial truck. Therefore, additional embodiments of the method 400 according to the invention can be derived from the embodiments of the transport robot 120a according to the invention described above.

1. A transport robot to carry out transport orders for transport of goods in a warehouse with a plurality of transport robots, the transport robot comprising:
a communication interface configured to receive an environment model of the warehouse and a capability model of the plurality of transport robots in the warehouse, wherein the environment model of the warehouse defines a plurality of key points of the warehouse and, for each key point, defines at least one neighboring key point, wherein the capability model defines, for each of the key points of the environment model, movement sequence data comprising at least one trajectory for an automated movement to the at least one neighboring key point, and wherein, for each key point of the plurality of key points of the plurality of key points of the environment model, the movement sequence data of the capability model is based on at least one movement learned by imitation learning of a manually operated transport robot of the plurality of transport robots between the key point and the at least one neighboring key point; and
a control unit to carry out a transport order from a starting key point to a destination key point of the plurality of key points and configured to control movement of the transport robot on the basis of the environment model and of the capability model.

2. The transport robot according to claim 1, wherein the control unit, to carry out the transport order from the start starting key point to the destination key point of the plurality of key points, is configured to control the movement of the industrial truck on the basis of the environment model and first movement sequence data comprising a first trajectory and at least second movement sequence data comprising a second trajectory of the capability model, wherein the first movement sequence data comprising the first trajectory defines a movement from the starting key point to an intermediate key point neighboring the starting key point, and wherein the at least second movement sequence data comprising the at least second trajectory defines a movement from the intermediate key point to the destination key point or a movement from the intermediate key point to an additional intermediate key point neighboring the intermediate key point.

3. The transport robot according to claim 2, wherein the control unit is further configured, after the movement of the industrial truck from the starting key point to the intermediate key point on the basis of the first movement sequence data comprising the first trajectory, to determine a deviation of a current position or current pose from a specified position or specified pose of the transport robot relative to the intermediate key point and to vary the movement of the transport robot from the intermediate key point to the destination key point or the additional intermediate key point on the basis of the second movement sequence information comprising the second trajectory to counteract the deviation of the current position or current pose from the specified position or specified pose.

4. The transport robot according to claim 2, wherein the control unit is further configured, by means of a cost function, to determine the movement of the transport robot from the starting key point to the destination key point via the one or more intermediate key points lying between the starting key point and the destination key point.

5. The transport robot according to claim 1, wherein each key point of the plurality of key points has a marking, and wherein the transport robot further comprises a sensor unit, which is configured to detect the marking of a respective key point and to identify the respective key point on the basis of the detected marking.

6. The transport robot according to claim 5, wherein the control unit is configured, on the basis of the marking detected by the sensor unit of a respective key point, to determine a position comprising a pose of the transport robot relative to the respective key point.

7. The transport robot according to claim 6, wherein the marking is a visual marking, and wherein the sensor unit comprises a depth sensing camera for detection of the visual marking.

8. The transport robot according to claim 1, wherein the transport robot further comprises a drive unit configured to drive the movement of the transport robot on the basis of movement control signals from the control unit.

9. The transport robot according to claim 1, wherein the transport robot is in the form of an industrial truck.

10. A system for operation of a plurality of transport robots in a warehouse, the system comprising:
a plurality of transport robots according to claim 1; and
a central device for the operation of the plurality of transport robots in the warehouse, wherein the central device is configured to make available to a transport robot of the plurality of transport robots the environment model of the warehouse and the capability model of the transport robots.

11. A method for operation of a transport robot to carry out transport orders for transport of goods in a warehouse with a plurality of transport robots, the method comprising:
receiving an environment model of the warehouse and a capability model of the plurality of transport robots in the warehouse, wherein the environment model of the warehouse defines a plurality of key points of the warehouse and, for each key point, at least one neighboring key point, wherein the capability model defines, for each of the key points of the environment model, movement sequence data comprising at least one trajectory for an automated movement to the at least one neighboring key point, and wherein, for each key point of the plurality of key points of the environment model, the movement sequence data of the capability model is based on at least one movement learned by imitation learning of a manually operated transport robot of the plurality of transport robots between the key point and the at least one neighboring key point; and
controlling movement of the transport robot on the basis of the environment model and of the capability model to carry out a transport order from a starting key point to a destination key point of the plurality of key points.
